(19) United States
(12) Patent Application Publication
(10) Pub. No.: US 2025/0013987 A1
(43) Pub. Date: Jan. 9, 2025

(54) PAY-PER-INTERVIEW METHOD, SYSTEM AND PLATFORM

(71) Applicant: Shiladitya Niyogi, Highland Park, IL (US)

(72) Inventor: Shiladitya Niyogi, Highland Park, IL (US)

(21) Appl. No.: 18/746,311

(22) Filed: Jun. 18, 2024

Related U.S. Application Data
(60) Provisional application No. 63/511,731, filed on Jul. 3, 2023.

(51) Int. Cl. G06Q 10/1053; G06Q 10/1093

(52) U.S. Cl. CPC G06Q 10/1053; G06Q 10/1095

(57) ABSTRACT

A method, system, and platform for compensating job candidates for interviews, while simultaneously providing employers with the ability to directly connect with qualified job candidates. The method, system and platform of the present invention includes at least one of a scheduling module, a payment module, a job board module, an artificial intelligence module, and a time tracker module. The method, system, and platform of the present invention further creates at least three distinct classes of users, namely, job candidates, employers, and subject matter experts.

### CROSS-REFERENCE TO RELATED APPLICATION

This application claims the benefit of priority of U.S. provisional application No. 63/511,731, filed 3 Jul. 2023, the contents of which are herein incorporated by reference.

### BACKGROUND OF THE INVENTION

The present invention relates to employment and hiring processes and, more particularly, to a pay-per-interview method, system, and platform.

The hiring process is often a time-consuming and nerve-wracking experience for job candidates and employers alike. Job candidates spend significant amounts of time and resources researching, visiting, and engaging with hiring managers and others at potential employers throughout the hiring process. Job candidates do all this knowing that they will not be compensated for those efforts and that there is a significant probability they will not secure a job with a given employer. For job candidates who are unemployed or under-employed, the uncompensated effort and possibility of remaining unemployed or under-employed can compound or even create feelings of hopelessness or other mental health issues.

For employers, conventional hiring processes can be time-consuming and waste valuable resources. Often employers need to go through recruiting agencies or engage with multiple vendors to find qualified job candidates, spending significant sums of time and money in the process. Further, there may be situations where employers only need temporary hires, such as subject matter experts, and significant hiring resources must be used to find someone who will only provide the employer with useful work for a short time. When employers use conventional job posting platforms, they must pay a fee to the platform to post a job listing. Conventional job posting platforms match candidates to employers using keywords, which can provide unqualified job candidates to employers, wasting time and resources for both the job candidates and the employers. Further, many conventional job posting platforms do not update job listings, thereby wasting job candidate and employer time when positions have already been filled or when job criteria may have changed.

As can be seen, there is a need for a method, system and platform that provides job candidates with compensation for the time and resources they expend while looking for jobs, and that provides employers with direct connections to qualified job candidates to avoid wasting the resources and time of both job candidates and employers. The present invention solves these problems by providing a pay-per-interview method, system, and platform that compensates job candidates for their time spent during the hiring process and provides employers with direct connections to qualified job candidates. The present invention thereby minimizes the expenses incurred by both job candidates and employers in the hiring process.

### SUMMARY OF THE INVENTION

In one aspect of the present invention, the computer implemented method for performing pay-per-interview hiring for a position involving a plurality of candidate users of a pay-per-interview system, the method includes the following: providing the pay-per-interview system comprising an artificial intelligence module (AIM), an automated payment module, a job board module, and a time track module, wherein the AIM is configured to match job skills to job search criteria for making a recommendation; entering one or more search criteria for the position by way of the job board module; selecting a pay rate for an interview for the position by way of the automated payment module; automatically recommending, by way of the AIM, at least one recommended candidate user of the plurality of candidate users based on one or more job skills residing in the job board module, wherein resulting from answers obtained from automated communications with the candidate users of the pay-per-interview system; initiating the interview with a first recommended candidate user of the at least one recommended candidate user for a time period automatically tracked by the time track module; and automatically transmitting a payment, by way of the automated payment module, to the first recommended candidate user, wherein the payment comprises a product of the pay rate and the time period.

In another aspect of the present invention, the computer-implemented method for performing pay-per-interview hiring for a position involving a plurality of candidate users of a pay-per-interview system wherein the pay-per-interview system further includes a scheduling module configured to facilitate initiating the interview; representing on a user interface, via the scheduling module, a calendar initiating the interview; representing on a user interface, via the scheduling module, the interview; automatically representing on the user interface, via the time track module, the time period juxtaposed the interview representation; automatically selecting, by way of the automated payment module, a default pay rate prior to the pay rate selection for the interview; automatically highlighting on the user interface, by way of the AIM, the one or more job skills associated with the recommendation, wherein the pay-per-interview system automatically prompts each candidate user for a pledge regarding a conflict preventing the candidate user from taking the position; automatically marking the recommendation upon completion of the interview, and wherein the job criteria comprise a salary, and wherein the pay rate is automatically modified based on the salary.

These and other features, aspects and advantages of the present invention will become better understood with reference to the following drawings, description and claims.

### BRIEF DESCRIPTION OF THE DRAWINGS

FIG. 1 shows a flow chart of employer use of a method, system, and platform according to an embodiment of the present invention.

FIG. 2 shows a flow chart of job candidate use thereof.

FIG. 3 shows a flow chart of subject matter expert use thereof.

FIG. 4 shows an exemplary interface as seen by an employer according to an embodiment of the present invention.

FIG. 5 shows an exemplary calendar in a scheduling module of a method, system, and platform according to an embodiment of the present invention.

FIG. 6 is a schematic screenshot of the platform's jobs recommendations, generated by an artificial intelligence module.

FIG. 7 is a schematic view of an exemplary embodiment of an action and alerts window on the profile portal.

FIG. 8 is a schematic view of an exemplary embodiment of a screen capture of the video conference with time tracker.

FIG. 9 is a block diagram of a general and/or special purpose computer 500, which may be a general and/or special purpose computing device, in accordance with some of the example embodiments of the invention.

FIG. 10. depicts an illustrative computing environment for implementing dynamic pay-per-interview functions in accordance with one or more aspects described herein.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The techniques of the present disclosure are illustrated as being implemented in a computing device such as a PC, laptop, tablet, smartphone, or other device capable of executing computer-executed instructions stored on a non-transient medium, e.g., memory, such as RAM, ROM, EPROM, flash memory and so on. Thus, the execution of steps in a process flow is by way of computer-execution of such steps, e.g., via a processor configured to retrieve the corresponding instructions from memory and execute them.

The platform, system, and method of the present invention may include at least one computer with access provided thereto by a user interface. The computer may include at least one processing unit coupled to a form of memory. The computer may include, but is not limited to, a microprocessor, a server, a desktop, laptop, and smart devices, such as, a tablet and smart phone. The computer includes a program product including a machine-readable program code for causing, when executed, the computer to perform steps. The program product may include systemic software which may either be loaded onto the computer or accessed by the computer. The loaded systemic software may include an application on a smart device. The systemic software may be accessed by the computer using a web browser. The computer may access the systemic software in part or entirely via the web browser using the internet, extranet, intranet, host server, internet cloud and the like.

Broadly, an embodiment of the present invention provides a method, system, and platform for compensating job candidates for interviews, while simultaneously providing employers with the ability to directly connect with qualified job candidates. The method, system and platform of the present invention includes at least one of a scheduling module, an automated payment module, a job board module, an artificial intelligence (AI) module, and a time tracker module. The method, system, and platform of the present invention further creates at least three distinct classes of users, namely, job candidates, employers, and subject matter experts (SMEs).

The scheduling module comprises at least one calendar function and a scheduling function. The calendar function provides users with a calendar where the user may enter their personal calendar information, e.g., manually or by synchronization with third party applications, and may further provide dates and times when the user is available to participate in interviews or other aspects of the hiring process. The calendar further allows users to edit their personal calendar information and availability as needed. The calendar function then allows others to view the users' calendar information via the scheduling function. The scheduling function allows users, e.g., employers and job candidates, to select available dates and times of others that the users would like to meet or interview. The scheduling function then schedules an interview or meeting between users at the selected time and date.

The payment module provides users with the ability to receive or make payments through the method, system, and platform of the present invention. The payment module provides job candidates with the ability set an hourly payment rate that the present invention then uses to determine the payment due from an employer to a job candidate for the job candidate's participation in an interview with the employer. The payment module also provides a default hourly payment rate, e.g., $50, if the job candidate does not select or set an hourly payment rate. The payment module provides employers with the ability to make payments to post job listings on to the job board module. The payment module further allows employers to make payments to job candidates or SMEs for interviews or to provide a portion of their job listing payments to the job candidates or SMEs for interviews.

The job board module comprises at least a job posting function, a candidate search function, and a job search function. The job posting function provides employers with the ability to post job listings and set matching criteria for job candidates and SMEs regarding the job listing. The candidate search function provides employers with the ability to search for job candidates and SMEs based on the matching criteria set by the employer for a particular job listing. The candidate search function interfaces with an artificial intelligence (AI) module to allow the AI module to parse information provided by job candidates and SMEs to determine the most qualified people for the relevant job listings being searched by the employer. AI model determines the most qualified candidate through identifying those who have successfully been selected in the past for similar jobs and determine suitability of candidates. The candidate search function further interfaces with the scheduling module to allow employers to schedule interviews with job candidates and SMEs. The job search function provides job candidates and SMEs with the ability to search for job listings that match skills provided by the job candidates and SMEs. The job search function interfaces with the AI module to allow the AI module to parse information provided by employers to determine the job listings and employers that best match the job candidate's or SME's search criteria and previous actions. The job search function further allows job candidates and SMEs to interface with the scheduling module and schedule interviews with employers for job listings when the job candidate or SME has been selected for an interview by the job listing's corresponding employer.

Further, the time tracker module provides users the ability to track time spent in interviews to properly calculate payments due for completed interviews. The time tracker module provides users with the ability to manually or automatically track time spent interviewing for a particular job listing. The time tracker module provides a start/stop button for manual tracking or interfaces with a video calling or web calling module to automatically track the time a user spends on the video call or web call. The time tracker module then interfaces with the payment module to calculate payment due to job candidates and SMEs based upon the hourly payment rate set by the job candidate or SME and the time spent interviewing.

The present invention thus provides a method, system, and platform to streamline hiring processes and for job candidates and SMEs to be paid for the time they spend interviewing. Thus, job candidates are fairly compensated for their time and given financial assistance as they search for stable employment. The present invention also allows employers to directly contact job candidates and SMEs, bypassing conventional middlemen and recruiting agencies. This shortens the hiring cycle for the employers and job candidates, saving valuable time and resources.

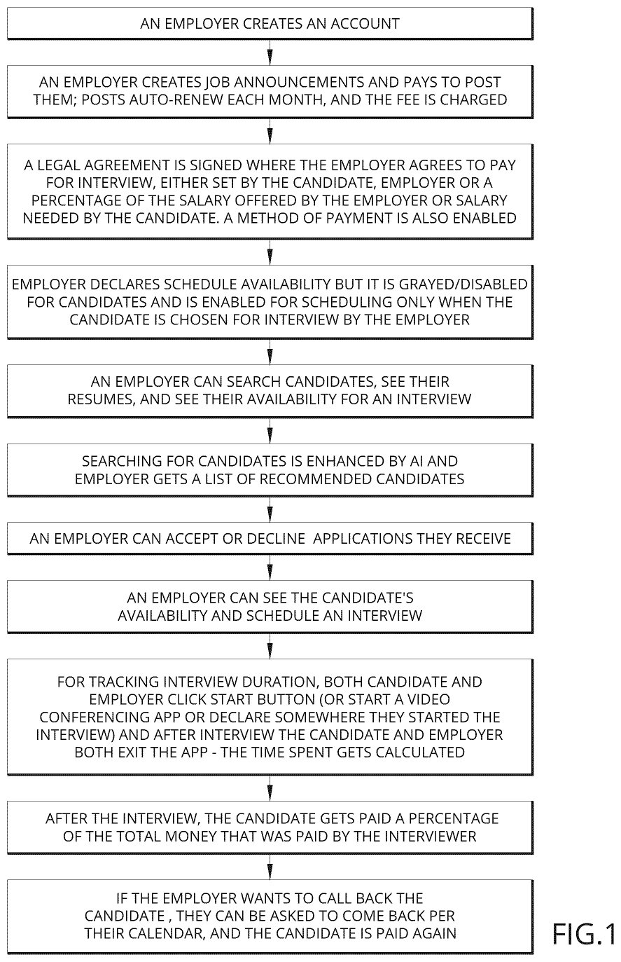

Referring now to FIGS. 1 through 8, an embodiment of a method, system, and platform in accordance with the present invention is provided. The method, system, and platform of the present invention is executed and housed in at least one server having an internet connection, e.g., via WiFi. The method, system, and platform of the present invention may be accessed via the internet by a user on a local device, e.g., a computer or smartphone, through a web browser or application on the local device. The user may then register with or log into the method, system, and platform of the present invention.

With reference to FIG. 1, a user experience for an employer is shown. The employer may create an account and register with the system. Once the account is created, the employer may create job listings via the job board module and make payments for the job listings through the payment module. The payment module may be set to automatically renew payments for job postings based upon the time a job posting remains on the system and platform, e.g., once a month. For job postings to be available on the platform, system and method of the present invention, the employer must agree to pay job candidates and SMEs for the interviews the employer holds with the job candidates and SMEs. The level of payment may be set by the job candidate or SME, the employer as a percentage of salary noted in the job listing, as a percentage of salary requested by the job candidate or SME, or via direct payment through the platform.

The employer may use the scheduling module to set date and time availability for interviews with selected job candidates and SMEs for a particular job listing. The scheduling module then makes the employer's interview schedule available for only the job candidates and SMEs selected for interviews by the employer. To choose qualified job candidates and SMEs for interviews, employers may use the job board module's candidate search function to find candidates based upon provided criteria. The AI module may then use the provided criteria to review job candidates and SMEs on the platform and provide the employer with recommended candidates. Employers may also accept or decline applications for job listings they receive from job candidates or SMEs.

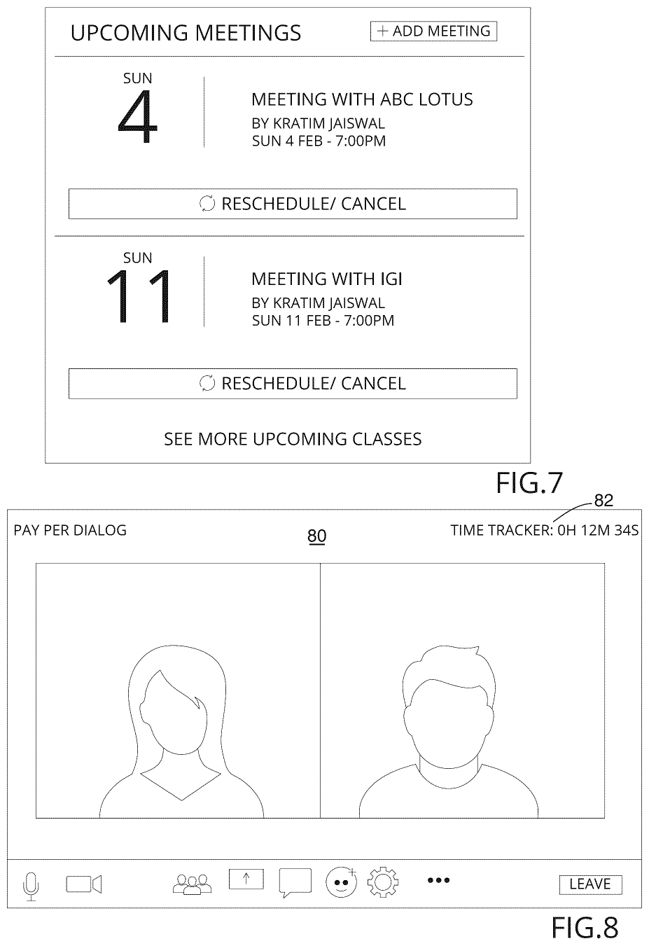

Once an employer finds a qualified job candidate or SME they would like to interview, the employer may use the scheduling module to view the job candidate's or SME's availability for an interview and schedule an interview. The scheduling module provides actions and alerts windows on a user's user interface to notify that user of an upcoming scheduled interview, as shown in FIG. 7.

Referring to FIG. 8, at the start of the scheduled interview, the employer and selected candidate may use the time tracker module to track the time spent in the interview, that is represented by a timekeeper 82 adjacent to or juxtaposed to the representation of the video conferencing 80 of the interview. Once the interview is completed, the time tracker module uses the total interview time to calculate payment due to the job candidate or SME. Once the payment due is calculated, the payment module transfers the payment due from the employer to the job candidate or SME.

Further, if the employer wishes to interview a particular job candidate or SME again, the system provides the employer with the ability to schedule an interview, track time, and make payment to the job candidate or SME again.

The employer user of the systemic platform/pay-per-interview software can search candidates, see their resumes, see their availability for an interview, and schedule an interview. The calendars of the employers and candidates are synched. There will be a screen for acceptance of payment if interviews are scheduled. The employer user pays a predetermined amount per job they post for a month or other predetermined period. Auto renew will charge the same amount every month till it gets removed. The employer user must also agree to pay a predetermined amount per interview that the company conducts.

The employer user can accept the applications for the next step (an interview) or decline the application. The employer user can also search candidates from the pool or set up a rule (AI or some other keyword based). employer user can schedule a meeting having visibility of the candidate's availability by way of the synched calendars. employer user can interview the candidates per the scheduled meeting, and then put a checkmark against the candidate for interview completion. Upon interview completion, the candidate gets paid a percentage of the total money that was paid by the interviewer. If the employer wants to call back the candidate, he/she can be asked to come back per his/her calendar and then similarly the candidate gets paid yet again.

The functions enabled by the systemic platform/pay-per-interview software include a Show Search Functionality providing a dashboard of possible job candidates (using simple search, AI, or other rules) that identifies a pool of matched or recommended job candidates matched or recommended SMEs as well as all applicants, including non-matched job candidates and SMEs who have applied for the job(s). The functions enabled by the systemic platform/pay-per-interview software include a Schedule Meeting Functionality enabling an employer to schedule an interview with a matched or recommended job candidate or matched or recommended SME (or any applicant having an account on the system). The Schedule Meeting Functionality, enabled by the scheduling module that integrates with the employer's calendar function with the selected applicant's calendar functions, provides markers and fields for scheduling post first round meetings on an employer user's user interface, whereby upon completion of the interview a payment screen, enabled by the payment module, comes up and then the employer user must make the payment (e.g., per a payment method selected when the employer was signed up).

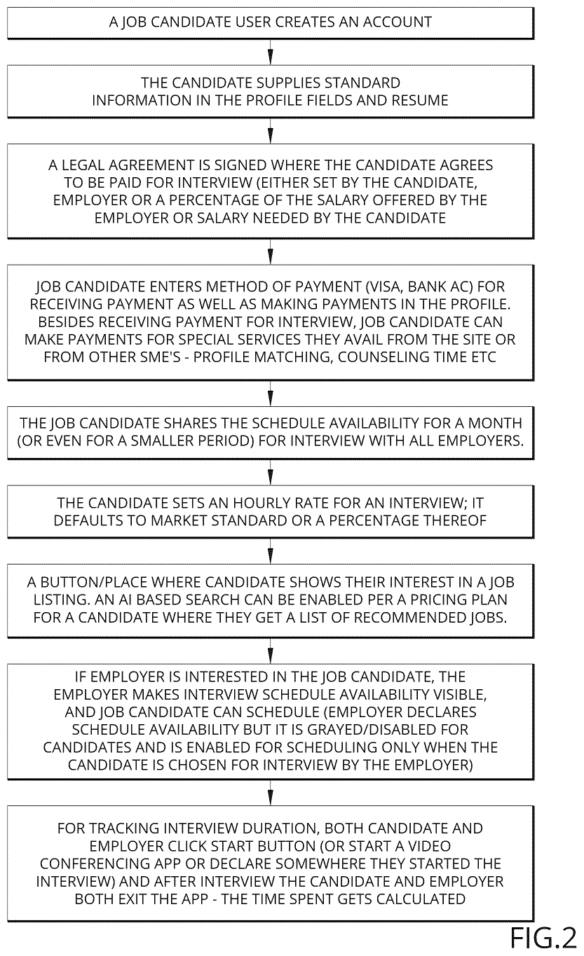

With reference to FIG. 2, a user experience for a job candidate is shown. The job candidate may create an account and register with the system. Once the account is created, the job candidate may provide information such as personal information or skills to create a profile and upload a resume to the platform. The job candidate must agree to make payment information available to the platform such that the job candidate may be paid by prospective employers for interviews the job candidate engages in. The job candidate may further use the payment module to pay for career counseling services, profile matching, or other similar services to elevate their profiles and resumes on the platform. The job candidate may further set an hourly payment rate they desire to have for interviews. If the job candidate does not select an hourly payment rate, the payment module selects a default hourly rate for the job candidate, e.g., $50.

The job candidate may use the scheduling module to set date and time availability for interviews with employers. The job candidate may set their availability for an indefinite time or select time periods, e.g., one month or one week. The scheduling module then makes the job candidate's interview schedule available for all employers. The job candidate may also use the job board's job search function to find jobs they may be interested in.

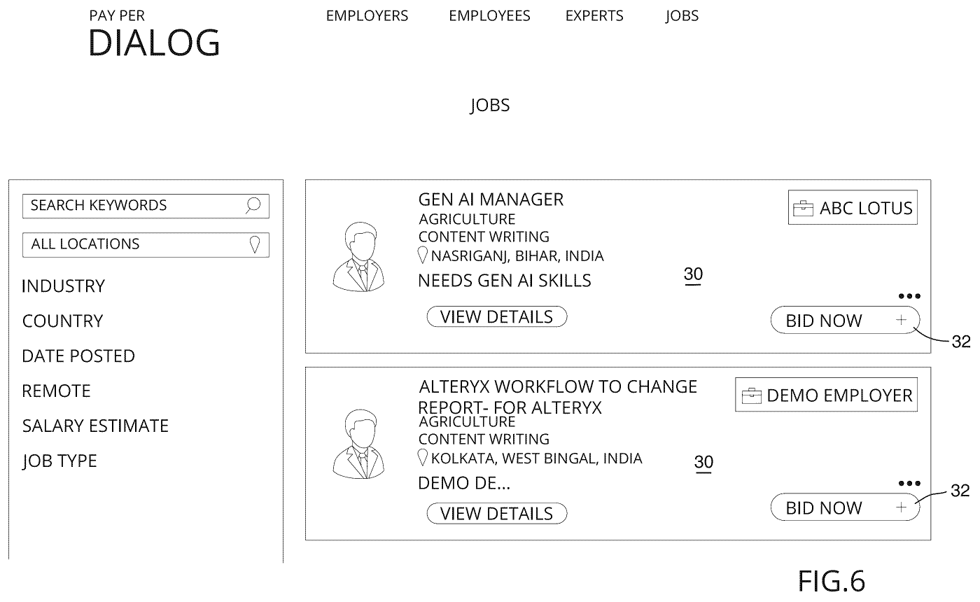

Referring to FIG. 6, a job candidate may engage the AI module to review the job candidate's profile and any search criteria the job candidate may provide to produce a list of recommended jobs 30 for the job candidate. If the job candidate is interested in a particular recommended job 30, the system provides a bid now button 32 on each job listing which the job candidate may select to indicate their interest.

Once an employer selects the job candidate for an interview, the employer's interview availability schedule becomes available to the job candidate. The job candidate may use the scheduling module to view the employer's availability for an interview and schedule an interview. At the start of the scheduled interview, the employer and selected candidate may use the time tracker module to track the time spent in the interview. Once the interview is completed, the time tracker module uses the total interview time to calculate payment due to the job candidate. Once the payment due is calculated, the payment module automatically transfers the payment due from the employer to the job candidate.

The job candidate user of the systemic platform/pay-per-interview software can apply to jobs like other job boards. There will be standard job searches (with titles, location, specialty, function, industry, among others). The candidate does not pay fees for applications. The candidate supplies standard information in the profile fields, updates availability in a calendar, along with an hourly rate to interview. The job candidate user can charge an hourly rate for interviewing. Even if the job candidate user doesn't specify, by default or as a minimum, the job candidate user will get a predetermined amount (or a percentage of the desired salary).

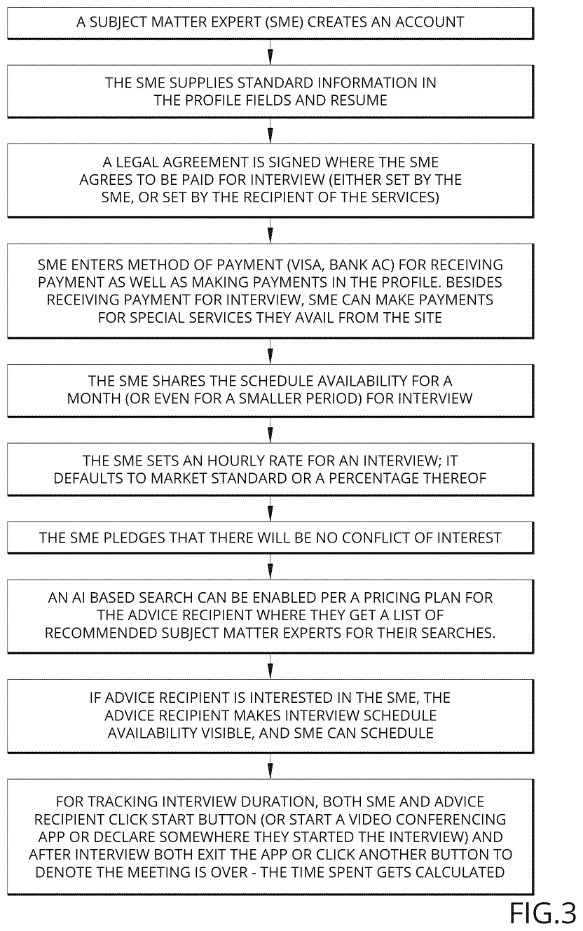

With reference to FIG. 3, a user experience for a SME is shown. The SME may create an account and register with the system. Once the account is created, the SME may provide information such as personal information or skills to create a profile and upload a resume to the platform. The SME must agree to make payment information available to the platform such that the SME may be paid by prospective employers or advisee for interviews the SME engages in. The SME may further use the payment module to pay for profile matching or other similar services to elevate their profiles and resumes on the platform. The SME may further set an hourly payment rate they desire to have for interviews. If the SME does not select an hourly payment rate, the payment module selects a default hourly rate for the job candidate, e.g., $50.

The SME may use the scheduling module to set date and time availability for interviews with employers. The SME may set their availability for an indefinite time or select time periods, e.g., one month or one week. The scheduling module then makes the SME's interview schedule available for all employers and advisees. The SME may also use the job board's job search function to find jobs they may be interested in. Once the SME's profile is available on the platform, the AI module may be used by employers and advisees to receive the SME's information through a recommendation list provided by the AI module. For jobs the SME is interested in the SME may make a pledge, by way of the job board module, that there is no conflict of interest preventing the SME from working with a prospective employer or advisee. It is understood that in certain embodiments, anyone who seeks advice from a SME is an advisee, wherein the advisee can be an employer, even a new VC or a research outfit without any employees.

Once an employer or advisee selects the SME for an interview, the employer's or advisee's interview availability schedule becomes available to SME. The SME may use the scheduling module to view the employer's or advisee's availability for an interview and schedule an interview. At the start of the scheduled interview, the employer or advisee and selected SME may use the time tracker module to track the time spent in the interview. Once the interview is completed, the time tracker module uses the total interview time to calculate payment due to the SME. Once the payment due is calculated, the payment module transfers the payment due from the employer or advisee to the SME.

The SME user can charge an hourly rate for interviewing after the SME pledges on a separate screen that there is no conflict of interest. A meeting can be arranged with the SME by a candidate or by a company to find out more about a certain area, wherein SME module acts like Guidepoint™, GLG™, or the like where companies ask the SME's on a topic and make payments through this system. The requester can schedule a meeting per SME's availability (per what the SME entered). The calendars of the SME's are synched with the user who requested the meeting. After the interview is conducted the requester can put a checkmark against the SME's profile for interview completion. Upon interview completion, the SME gets paid a percentage of the total money that was paid by the interviewer.

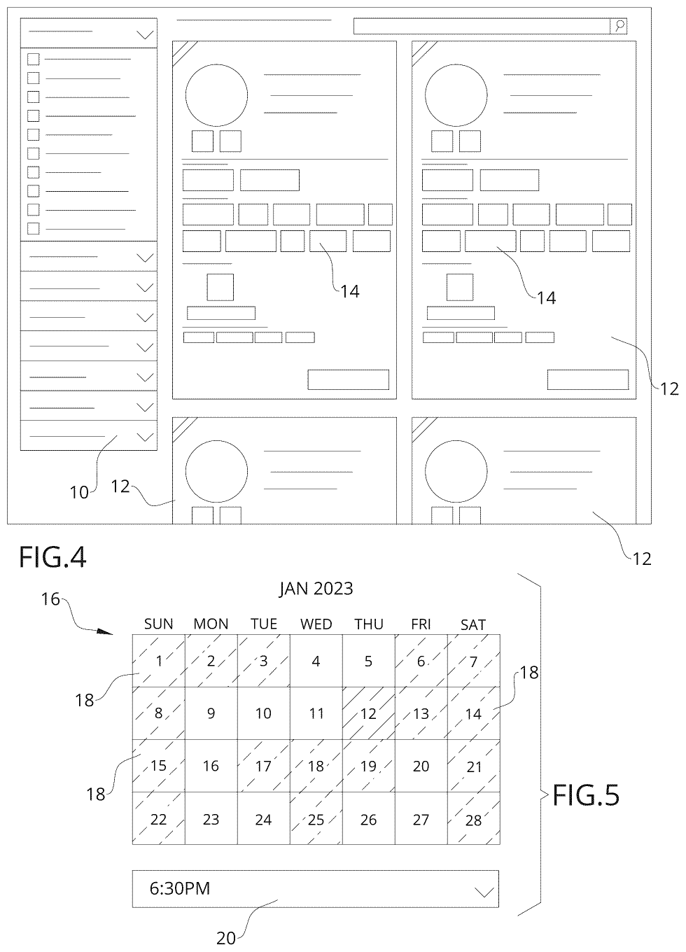

With reference to FIG. 4, an exemplary candidate search interface is depicted. Upon using a menu 10 to engage with a candidate search function in the job board module, an employer may use the AI module to produce a list of matched or recommended job candidates' profiles 12. The AI module highlights the skills 14 relevant to the employer's search criteria and job listing to ensure the employer sees all the relevant skills a job candidate 12 possesses. Further, as best seen in FIG. 5, once the opportunity for an interview has been set, users may use the scheduling module to select a time and date for an interview. The scheduling module presents calendar 16 showing interview availability to a user. The calendar 16 grays out or otherwise obscure unavailable days 18 so that the user knows interviews cannot be held on those dates. Once an available date is selected by the user, the scheduling module provides a time selector 20 in which the user may select a desired time on the selected date.

The present invention thus provides a method, system, and platform to streamline hiring processes and for job candidates and SMEs to be paid for the time they spend interviewing. Thus, job candidates are fairly compensated for their time and given financial assistance as they search for stable employment. The present invention also allows employers to directly contact job candidates and SMEs, bypassing conventional middlemen and recruiting agencies. This shortens the hiring cycle for the employers and job candidates, saving valuable time and resources.

While the present invention has been primarily discussed in terms of scheduling interviews where payment is made to job candidates or SMEs, the present invention may also be used to schedule meetings or calls where no payment need be made. Further, the present invention may further be used to make charitable payments, as a social or startup funding application, to coordinate payment transactions between parties, to connect hiring companies and job candidates without the need for any payment transaction, to track time for meetings and similar events, or other similar activities requiring payment, scheduling, or time tracking.

The computer-based pay-per-interview platform, system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

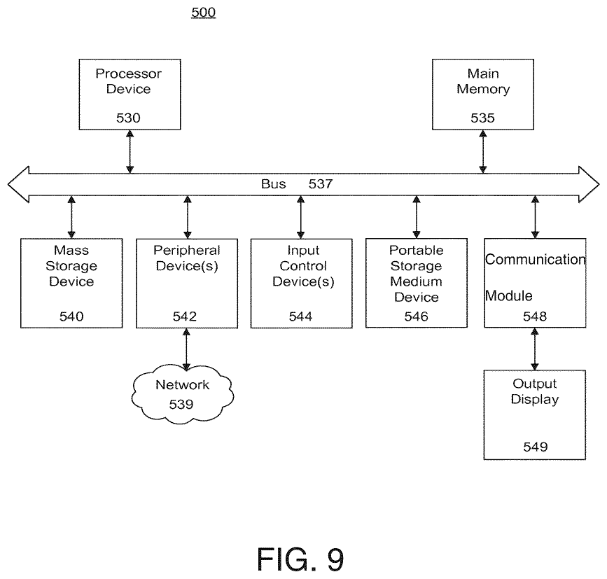

Referring to FIG. 9, the computer 500 may be, for example, a user device, a user computer, a client computer and/or a server computer, among other things. The computer 500 may include without limitation a processor device 530, a main memory 535, and an interconnect bus 537. The processor device 530 may include without limitation a single microprocessor or may include a plurality of microprocessors for configuring the computer 500 as a multi-processor system. The main memory 535 stores, among other things, instructions and/or data for execution by the processor device 530. The main memory 535 may include banks of dynamic random-access memory (DRAM), as well as cache memory.

The computer 500 may further include a mass storage device 540, peripheral device(s) 542, non-transitory storage medium device(s) 546, input control device(s) 544, a graphics subsystem 548, and/or a display 549. For explanatory purposes, all components in the computer 500 are shown in FIG. 9 as being coupled through the bus 537. However, the computer 500 is not so limited. Devices of the computer 500 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 500. In some embodiments, the software for storing information may be stored on a portable storage medium and may be inputted into the computer 500 via the portable storage medium device 546. The peripheral device(s) 542 may include any type of computer support device, such as, for example, an input/output (I/O) interface configured to add additional functionality to the computer 500. For example, the peripheral device(s) 542 may include a network interface card for interfacing the computer 500 with a network 539.

The input control device(s) 544 provides a portion of the user interface for a user of the computer 500. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. To display textual and graphical information, the computer 500 may include the graphics subsystem 548 and the output display 549. The output display 549 may include a cathode ray tube (CRT) display and/or a liquid crystal display (LCD). The graphics subsystem 548 receives textual and graphical information and processes the information for output to the output display 549.

Each component of the computer 500 may represent a broad category of a computer component of a general and/or special purpose computer. Components of the computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any software configuration. They may find applicability in any computing or processing environment. The terms “computer-readable”, “machine-accessible medium” or “machine-readable medium” used herein shall include any medium that can store, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nano-systems, a molecular memory integrated circuit, a RAID, remote data storage/archive/warehousing, and/or any other type of device suitable for storing instructions and/or data.

Stored on any one of the computers readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the present invention have been described above, they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

In addition, the accompanying figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

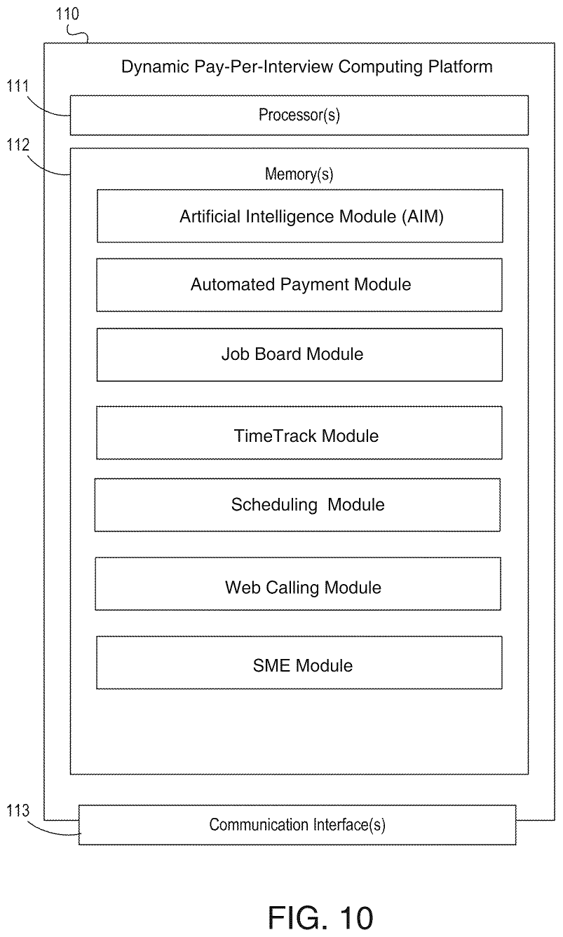

Referring to FIG. 10, the dynamic pay-per-interview computing platform 110 may include one or more processors 111, memory 112, and communication interface 113. The data bus 537 may interconnect processor(s) 111, memory 112, and communication interface 113. Communication interface 113 may be a network interface configured to support communication between pay-per-interview computing platform 110 and one or more networks (e.g., private network 190, public network 195, or the like). Memory 112 may include one or more program modules having instructions that when executed by processor(s) 111 cause dynamic pay-per-interview computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of cognitive automation pay-per-interview computing platform 110 and/or by different computing devices 500 that may form and/or otherwise make up the dynamic pay-per-interview computing platform 110.

It should be understood, of course, that the foregoing relates to exemplary embodiments of the invention and that modifications may be made without departing from the spirit and scope of the invention as set forth in the following claims.

What is claimed is:

1. A computer-implemented method for performing pay-per-interview hiring for a position involving a plurality of candidate users of a pay-per-interview system, the method comprising:
providing the pay-per-interview system comprising an artificial intelligence module (AIM), an automated payment module, a job board module, and a time track module, wherein the AIM is configured to match job skills to job search criteria for making a recommendation;
entering one or more search criteria for the position by way of the job board module;
selecting a pay rate for an interview for the position by way of the automated payment module;
automatically recommending, by way of the AIM, at least one recommended candidate user of the plurality of candidate users based on one or more job skills residing in the job board module, wherein resulting from answers obtained from automated communications with the candidate users of the pay-per-interview system;
initiating the interview with a first recommended candidate user of the at least one recommended candidate user for a time period automatically tracked by the time track module; and
automatically transmitting a payment, by way of the automated payment module, to the first recommended candidate user, wherein the payment comprises a product of the pay rate and the time period,
whereby every dialog or conversation needs to be paid.

2. The method of claim 1, wherein the pay-per-interview system further comprises a scheduling module configured to facilitate initiating the interview.

3. The method of claim 2, further representing on a user interface, via the scheduling module, a calendar initiating the interview.

4. The method of claim 3, further representing on a user interface, via the scheduling module, the interview.

5. The method of claim 4, further automatically representing on the user interface, via the time track module, the time period juxtaposed the interview representation.

6. The method of claim 5, further automatically selecting, by way of the automated payment module, a default pay rate prior to the pay rate selection for the interview.

7. The method of claim 6, further automatically highlighting on the user interface, by way of the AIM, the one or more job skills associated with the recommendation.

8. The method of claim 7, wherein the pay-per-interview system automatically prompts each candidate user for a pledge regarding a conflict preventing the candidate user from taking the position.

9. The method of claim 8, further automatically marking the recommendation upon completion of the interview.

10. The method of claim 9, wherein the job criteria comprise a salary, and wherein the pay rate is automatically modified based on the salary.

11. A computing platform, comprising:
at least one processor;
a communication interface communicatively coupled to the at least one processor; and
a memory storing computer-readable instructions that, when executed by the at least one processor, cause the computing platform to:
provide an artificial intelligence module (AIM), an automated payment module, a job board module, and a time track module, wherein the AIM is configured to match job skills to job search criteria for making a recommendation;
receive one or more search criteria for the position by way of the job board module;
select a pay rate for an interview for the position by way of the automated payment module;
automatically recommend, by way of the AIM, at least one recommended candidate user of the plurality of candidate users based on one or more job skills residing in the job board module, wherein resulting from answers obtained from automated communications with the candidate users of the pay-per-interview system;
initiate the interview with a first recommended candidate user of the at least one recommended candidate user for a time period automatically tracked by the time track module; and
automatically transmit a payment, by way of the automated payment module, to the first recommended candidate user, wherein the payment comprises a product of the pay rate and the time period, whereby every dialog or conversation needs to be paid.

12. The system of claim 11, wherein the pay-per-interview system further comprises a scheduling module configured to facilitate initiating the interview.

13. The system of claim 12, further comprising represent on a user interface, via the scheduling module, a calendar initiating the interview.

14. The system of claim 13, further comprising represent on a user interface, via the scheduling module, the interview.

15. The system of claim 14, further automatically represent on the user interface, via the time track module, the time period juxtaposed the interview representation.

16. The system of claim 15, further automatically select, by way of the automated payment module, a default pay rate prior to the pay rate selection for the interview.

17. The system of claim 16, further automatically highlight on the user interface, by way of the AIM, the one or more job skills associated with the recommendation.

18. The system of claim 17, wherein the pay-per-interview system automatically prompts each candidate user for a pledge regarding a conflict preventing the candidate user from taking the position.

19. The system of claim 18, further automatically mark the recommendation upon completion of the interview.

20. The system of claim 19, wherein the job criteria comprise a salary, and wherein the pay rate is automatically modified based on the salary.
